(19) United States
(12) Patent Application Publication
(10) Pub. No.: US 2008/0129362 A1
(43) Pub. Date: Jun. 5, 2008

(54) SEMICONDUCTOR DEVICE AND METHOD OF DESIGNING SEMICONDUCTOR DEVICE

(76) Inventor: Tadayuki Kawai, Kanagawa (JP)

Correspondence Address: MCDERMOTT WILL & EMERY LLP, 600 13TH STREET, NW, WASHINGTON, DC, 20005-3096, US

(21) Appl. No.: 11/946,237

(22) Filed: Nov. 28, 2007

(30) Foreign Application Priority Data
Nov. 30, 2006 (JP) P. 2006-323098

(51) Int. Cl. G06F 1/04; G06F 17/50

(52) U.S. Cl. 327/292; 716/6

(57) ABSTRACT

A semiconductor device designing method of the present invention corresponds to a method for designing a clock synthesization type semiconductor device, which is comprised of: a rough CTS (clock tree synthesis) step for performing the CTS within an adjustable range in multiple phases; a timing check step for judging whether or not transmission/reception of data are carried out under normal condition based upon a propagation time of data and an arrival time of a clock signal between flip-flops; a detailed timing analyzing step for judging whether or not the transmission/reception of the data can be carried out under the normal condition by switching a phase of a clock signal, or by increasing/decreasing a buffer in a half way of the clock tree as to supply timing of the clock signal; and a re-allocating step of a CLK net, for allocating a phase of such a clock signal which does not cause a timing violation every flip-flop based upon the result of the detailed timing analyzing step.

### BACKGROUND OF THE INVENTION

1. Field of the Invention

The present invention generally relates to a semiconductor device. More specifically, the present invention is directed to a semiconductor device capable of simultaneously realizing low power consumption, a reduction of a developing term, a reduction of an area, and a high-speed operation, and also directed to a method for designing the semiconductor device.

2. Description of the Related Art

Very recently, semiconductor devices have been manufactured in very fine manners, so that structures of these semiconductor devices have become complex, developing terms of the semiconductor devices have been prolonged, and these semiconductor devices have been equipped with higher functions. On the other hand, in order to accept requirements of high-speed operations, in method for designing semiconductor devices with employment of CMOS circuits, there are various contrary requirements, for instance, high-speed operation as well as low power consumption, and higher functions as well as reductions of developing terms. Also, reductions of areas of these semiconductor devices are required in order to realize low costs.

In the present stage, among methods for designing semiconductor devices which are installed in digital electric appliances, synchronization designing methods for designing semiconductor devices by synchronizing clock signals have been mainly employed. Generally speaking, when semiconductor devices are designed, a clock tree synthesis (will also be referred to as “CTS” hereinafter) has been employed in order that reaching times of clock signals from a supply source of the clock signals to flip-flops (will also be referred to as “F/F” hereinafter) are uniformly matched with each other.

The below-mentioned layout methods have been widely employed in order that a difference in clock reaching times (will also be referred to as “Skew” hereinafter) among these flip-flops may be approximated to zero as being permitted as possible: That is, in the layout methods, clock signal buffers are arranged and wired in an “H” shape so as to equalize loads given to these clock buffers.

However, it is physically difficult to completely match the Skew to zero, and on the other hand, in order to approximate the Skew to zero as being permitted as possible, a large number of layout steps are required. In addition, in connection with progress of manufacturing in very fine manner, such designing/operation guarantees have been required by considering the following aspects, namely layout density is rapidly increased; physical phenomena are clearly expressed; temperatures are locally increased; and also, power supply voltages are dropped.

When timing designing operations and verifying operations are carried out, such timing designing operations are necessary required by adapting predetermined design margins (set-up margin, holding margin, temperature characteristic margin, voltage characteristic margin, process fluctuation margin etc.) with respect to reaching times of clock signals to flip-flops and reaching times of data to flip-flops. When synchronization designing operations are carried out, since semiconductor devices are designed by employing clock signals as a reference, if a plurality of timing are not made coincident with each other, then delay-purpose buffers are inserted, circuits provided on the data side are changed, and sizes of Tr (transistors) are changed, and the like in order to adjust (delay, or lead) progation times on the data side.

Since these buffers having useless functions are inserted, electric power is consumed, areas are consumed, and wiring resources are consumed. In addition, useless circuit elements are increased, semiconductor devices may be readily influenced by process fluctuations. As a result, timing guarantees are necessarily required in addition to the design margins.

As designing methods capable of solving the above-explained CTS problems, such a designing method (refer to, for example, patent publication 1) has been proposed by which dummy capacitances are added to clock pins (will also be referred to as “CLK pins” hereinafter) of flip-flops in a virtual manner so as to re-arrange the CTS.

This CTS re-arranging design method sequentially executes, as shown in FIG. 11, an arranging step 900, a CTS step 901, a wiring step 902, an LPE step 903, an evaluating step 904, and an ECO step 905. That is, the arranging step 900 automatically arranges logic cells based upon previously produced circuit connection information, while the logic cells correspond to circuit elements which constitute a semiconductor device. The CTS step 901 automatically performs a clock wiring operation with respect to a clock signal line by a computer by employing the CTS manner. The wiring step 902 automatically produces wiring lines among the logic cells except for the clock wiring lines. The LPE step 903 extracts wiring capacitances and wiring resistances. The evaluating step 904 performs a delay simulation by actual wiring lines with employment of the circuit connection information, and the wiring capacitances and the wiring resistances extracted in the LPE step 903. The ECO step 905 re-arranges the wiring lines in a layout.

In accordance with the above-described designing method, after the logic cells have been arranged and the wiring operations among the logic cells have been carried out, such flip-flops related to timing errors (namely, set-up time errors, or hold time errors) are detected, and dummy capacitances are added to clock input terminals of the detected flip-flops in the virtual manner so as to perform the CTS process operation. As a result, the re-designing process operation in the gate levels, the RTL levels, or the system level is no longer required, which was required in the conventional designing method, so that the designing term can be shortened.

Patent Publication 1: JP-A-2001-175699

However, in the above-described conventional designing method, in order that the reaching times of the clock signals from the supply source for the clock signals are matched with each other, and also, the differences in the clock signal reaching times among the respective flip-flops are approximated to zero as being permitted as possible, the clock buffer arrangement has been positionally adjusted and also the clock signal wiring operation has been performed. Furthermore, in the case that Skew is large, the delay elements such as the buffers have been inserted in all of other paths in the CTS step in order that the clock signal reaching times are made substantially coincident with the clock signal reaching time from the clock signal supply source up to the latest path.

With respect to the clock signals adjusted to this zero Skew, the timing adjustment is carried out by adapting the set-up margin, the holding margin, the temperature characteristic, the voltage characteristic, and the process fluctuation to the propagation times on the data side of the flip-flops. As a result, the functionally useless delays are required on the data side, so that the timing adjustment is carried out by inserting a large number of these buffers.

As a consequence, the power consumption is increased, the area is consumed, and the wiring resource is consumed, and moreover, since the functionally useless elements are increased, such a timing guarantee by considering the adverse influence caused by the process fluctuation is required, so that difficulties of the designing method are increased. In addition, since a delay time per a single delay element becomes short due to a manufacture in a very fine manner, larger numbers of delay elements are necessarily required, and thus, a total number of steps required in timing designing operations are rapidly increased.

Also, in the designing method recited in the above-described patent publication 1, such a timing error except for the relevant portion does not newly occur. As a result, while the arrangement and the clock signal wiring lines except for this relevant portion are not changed, the delay time equivalent to the dummy capacitance added to the CLK pin must be newly produced only in the clock signal wiring lines. When this delay time requires such a value larger than, or equal to a predetermined time, such a large delay time can be hardly realized.

### SUMMARY OF THE INVENTION

The present invention has been made to solve the above-described problems, and therefore, has an object to provide a semiconductor device capable of simultaneously realizing low power consumption, a reduction of a developing term, a reduction of an area, and a high-speed operation, and also to provide a method for designing the semiconductor device.

A method for designing a semiconductor device, according to the present invention, is featured by that in a method for designing a clock synchronization type semiconductor device, the semiconductor device designing method is comprised of: a rough CTS (clock tree synthesis) step for performing the CTS within an adjustable range in multiple phases; a timing check step for judging whether or not transmission/reception of data are carried out under normal condition based upon a propagation time of data and an arrival time of a clock signal between flip-flops; a detailed timing analyzing step for judging whether or not the transmission/reception of the data can be carried out under the normal condition by switching a phase of a clock signal, or by increasing/decreasing a buffer in a half way of the clock tree as to supply timing of the clock signal; and a re-allocating step of a CLK net, for allocating a phase of such a clock signal which does not cause a timing violation every flip-flop based upon the result of the detailed timing analyzing step.

The above-described designing method has an initial condition that while the clock signal having the single phase is not supplied which has been performed in the conventional designing method, clock signals having multiple phases are supplied. Also, while a Skew target value when CTS is designed is not selected to be zero, the semiconductor device is designed in such a manner that such clock signal phases having the smallest time difference value are selected to be supplied in coincident with timing of transmission/reception time (will also be referred to as “propagation time” hereinafter) on the data sides between the flip-flops. As a consequence, it is possible to omit the step for providing the delay buffers which have been inserted only for the timing adjustment and have the useless function in the conventional designing method. Accordingly, in accordance with the designing method of the present invention, both the CTS manner which is necessarily required in the timing design, and also, the transmission/reception timing as to the clock signals and the data among the flip-flops can be effectively designed.

Also, in accordance with the semiconductor device designing method of the present invention, in the detailed timing analyzing step, a delay difference between repeaters may be alternatively considered which are arranged between a supply source of the clock signal and the clock tree.

As a result, the timing can be more effectively adjusted.

Also, in accordance with the semiconductor device designing method of the present invention, in the CLK net re-allocating step, the phase of the clock signal may be alternatively changed by referring to a peak current so as to reduce the peak current.

As a consequence, the timing design margin made by considering the local voltage drop of the power supply when the semiconductor device is operated can be decreased, and the current supply capability of the regulator which is mounted at the same time on the product can be reduced, so that the entire cost of the semiconductor device (system) can be lowered.

Also, in accordance with the semiconductor device designing method of the present invention, in the detailed timing analyzing step, both a measuring step for measuring a manufacturing fluctuation of a process, and a correction value calculating step for calculating a correction value which corrects a deviation width with respect to a Typ condition every clock signal phase value based upon the measurement result may be alternatively carried out; and also, in the CLK net re-allocating step, the phase of the clock signal may be alternatively changed by referring to the correction value so as to allocate the changed clock signal phase.

In such a case that only any one sort of larger violations among the set-up violations and the holding violations every clock signal, which are used in the semiconductor device, are adjusted based upon the clock phase in accordance with the above-described designing method, when completion values every semiconductor device which are acquired form the plurality of measuring means arranged at arbitrary positions within the semiconductor device are present within a range from a Typ value up to a best value, the completion values are directly employed, whereas when completion values every semiconductor device are present within a range from the Typ value up to the worst value, a deviation width from the Typ condition is calculated so as to obtain a correction value with respect to each of the clock signal phase values, and then, these calculated correction values are fed back to the multi-phase generating apparatus. As a result, such a flip-flop which is brought into the timing violation in the range from the Typ condition to the worst condition can be operated under normal condition.

Also, a semiconductor device of the present invention is manufactured by employing any of the above-described designing methods.

The above-described semiconductor device may be alternatively comprised of: a multi-phase generating apparatus capable of supply clock signals having a plurality of phases; a measuring circuit for measuring a manufacture fluctuation of a process; a calculating circuit for calculating a correction value of a phase of the clock signal based upon a deviation width from a Typ condition; and adjusting means for adjusting a timing violation under the worst condition after said semiconductor device has been manufactured.

Also, in the semiconductor device of the present invention, the multi-phase generating apparatus may be alternatively arranged by a PLL (phase-locked loop) circuit.

With employment of the above-described arrangement, the clock signal may be supplied under stable condition without receiving adverse influences caused by a temperature characteristic and a voltage characteristic.

Also, in the semiconductor device of the present invention, a phase generating unit of the multi-phase generating apparatus may be alternatively constituted by an MOS (metal oxide semiconductor) element having a delay function.

With employment of the above-described arrangement, the clock signal may be supplied without receiving a restriction of an arrangement on a layout.

According to the present invention, it is possible to provide such a semiconductor device capable of simultaneously realizing the low power consumption, the reduction of the developing term, the reduction of the area, and the high-speed operation, and also to provide such a method for designing the semiconductor device.

### BRIEF DESCRIPTION OF THE DRAWINGS

FIG. 1 is a schematic structural diagram of a clock tree employed in a method for designing a semiconductor device, according to an embodiment mode 1 of the present invention.

FIG. 2 is a schematic structural diagram of a semiconductor device which is designed by a designing method according to the embodiment mode 1 of the present invention.

FIG. 3 is a flow chart for describing the designing method of the embodiment mode 1 of the present invention.

FIG. 4 shows a data propagation relationship diagram of the data propagated among flip-flops.

FIG. 5 indicates timing margin/violation graphs every path.

FIG. 6 is an explanatory diagram for explaining a reduction of peak power.

FIG. 7 is a schematic structural diagram of a semiconductor device which is designed by a designing method according to an embodiment mode 2 of the present invention.

FIG. 8 is a diagram for representing a relationship between the semiconductor of FIG. 7 and a regulator.

FIG. 9 graphically shows all of timing “Slack.”

FIG. 10 is a schematic structural diagram of a semiconductor device which is designed by a designing method according to an embodiment mode 3 of the present invention.

FIG. 11 is the flow chart for describing the conventional designing method of the semiconductor device.

### DESCRIPTION OF THE PREFERRED EMBODIMENTS

Referring now to drawings, a detailed description is made of various embodiment modes of the present invention.

### Embodiment Mode 1

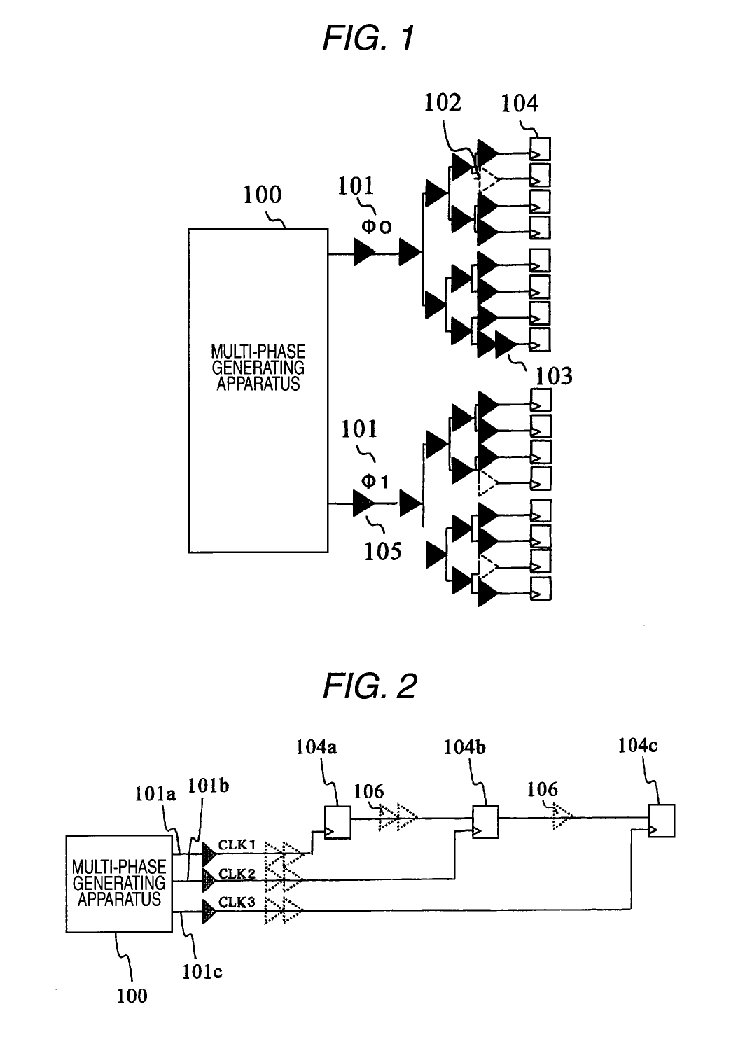

A description is made of a method for designing a semiconductor device according to an embodiment mode 1 of the present invention. Firstly, a description is made of a clock tree which is employed in the method for designing the semiconductor device according to the embodiment mode 1. FIG. 1 is a diagram for showing a schematic structure of the clock tree which is employed in the method for designing the semiconductor device according to the embodiment mode 1. A multi-phase generating apparatus 100 shown in FIG. 1 is capable of supplying clock signals having a plurality of phases, and is used in order to supply clock signals having optimum phases within an adjustable range by considering propagation times on the data sides of flip-flops. The way for adjustments will be discussed later.

Reference numeral 101 indicated in FIG. 1 represents phases of plural clock signals which are supplied from the multi-phase generating apparatus 100. In addition to a method for adjusting a phase of a clock signal, in the method for designing the semiconductor device according to the embodiment mode 1, since a buffer corresponding to the structural elements of the clock tree may be added in a half way of the clock tree so as to delay supply timing of the clock signals in a fine manner, or the above-described buffer may be alternatively deleted from the clock tree so as to lead the supply timing of the clock signals in a fine manner, the supply timing of the clock signals to the flip-flop may be fine-adjusted.

Reference numeral 102 shown in FIG. 1 exemplifies such a buffer which has been deleted in order to adjust supply timing of clock signals to flip-flops. Reference numeral 103 shown in FIG. 1 exemplifies such a buffer which has been added in order to adjust supply timing of clock signals to flip-flops. A repeater 105 is employed in order to supply clock signals supplied from the multi-phase generating apparatus 100 to the clock tree.

As previously described, the clock signals supplied from the multi-phase generating apparatus 100 are supplied via the repeater 105 and the respective buffers to flip-flops 104.

FIG. 2 is a schematic structural diagram of a semiconductor device which has been designed in accordance with the designing method of the embodiment mode 1. The multi-phase generating apparatus 100 has supplied a clock signal CLK 1 via a wiring line 101a to a flip-flop 104a. Also, the multi-phase generating apparatus 100 has supplied a clock signal CLK 2 via a wiring line 101b to a flip-flop 104b. Further, the multi-phase generating apparatus 100 has supplied a clock signal CLK 3 via a wiring line 101c to a flip-flop 104c. As to the respective clock signals, for instance, while the clock signal CLK 1 is employed as a reference clock signal, a phase of the clock signal CLK 2 is shifted to a plus direction from the phase of the clock signal CLK 1, whereas a phase of the clock signal CLK 3 is shifted to a minus direction from the phase of the clock signal CLK 1.

Reference numeral 106 shows a delay buffer provided on the data side, and this delay buffer 106 may be deleted in accordance with the designing method of the present invention.

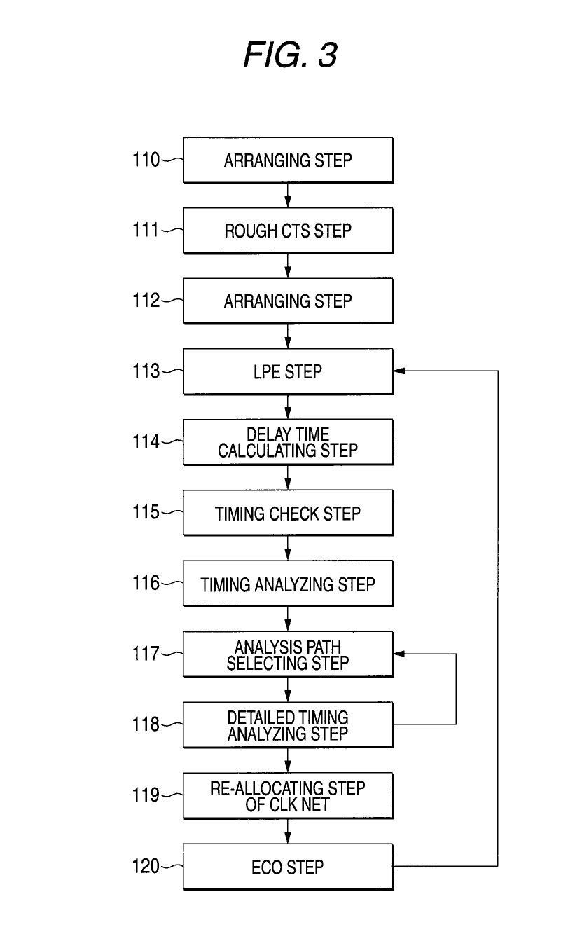

FIG. 3 is a flow chart for indicating the designing method of the embodiment mode 1. In this flow chart, an arranging step 110 is a step for automatically arranging a plurality of logic cells based upon layout information of the logic cells and circuit connection information which has been previously produced. A rough CTS step 111 is a step for performing CTS (clock tree synthesis) in an adjustable range (for example, if clock signal frequency is 125 MHz, then phase is 8 ns) in multiple phases, not the CTS by the conventional zero Skew.

A wiring line step 112 is a step for producing wiring lines among the logic cells except for clock signal wiring lines. An LPE step 113 is a step for calculating stray capacitances and stray resistances of the wiring lines. A delay time calculating step 114 is a step for calculating a delay time with respect each of temperature conditions and of voltage conditions based upon the values calculated in the LPE step 113 and information required to calculate delay times related to logic cells, which have been previously prepared.

A timing check step 115 is a step for judging whether or not transmission/reception of data are carried out under normal operation based upon propagation times among flip-flops and reaching times of clock signals. A timing analyzing step 116 is such a step for analyzing whether or not there is a marging in data transmission/reception timing every same clock signal, whether or not the data transmission/reception are violated, or whether or not the data transmission/reception are violated only under the worst condition based upon the timing check result obtained in the timing check step 115, and then, for classifying the analyzed results.

An analysis path selecting step 117 is a step for selecting and extracting all of flip-flops every path, which are related to the data transmissions/receptions among the flip-flops based upon the timing analysis results obtained in the timing analyzing step 116. A detailed timing analyzing step 118 is a step for judging whether or not the data transmissions/receptions can be carried out under normal condition by merely switching supply timing of clock signals every path at clock signal phases, or by merely increasing/decreasing a buffer in a half way of the clock tree.

A re-allocating step 119 of a CLK net corresponds to a step for judging whether or not the CLK phase is switched based upon the analysis result of the detailed timing analyzing step 118. An ECO step 120 is such a step for reflecting the result of the re-allocating step 119 of the CLK net to a layout.

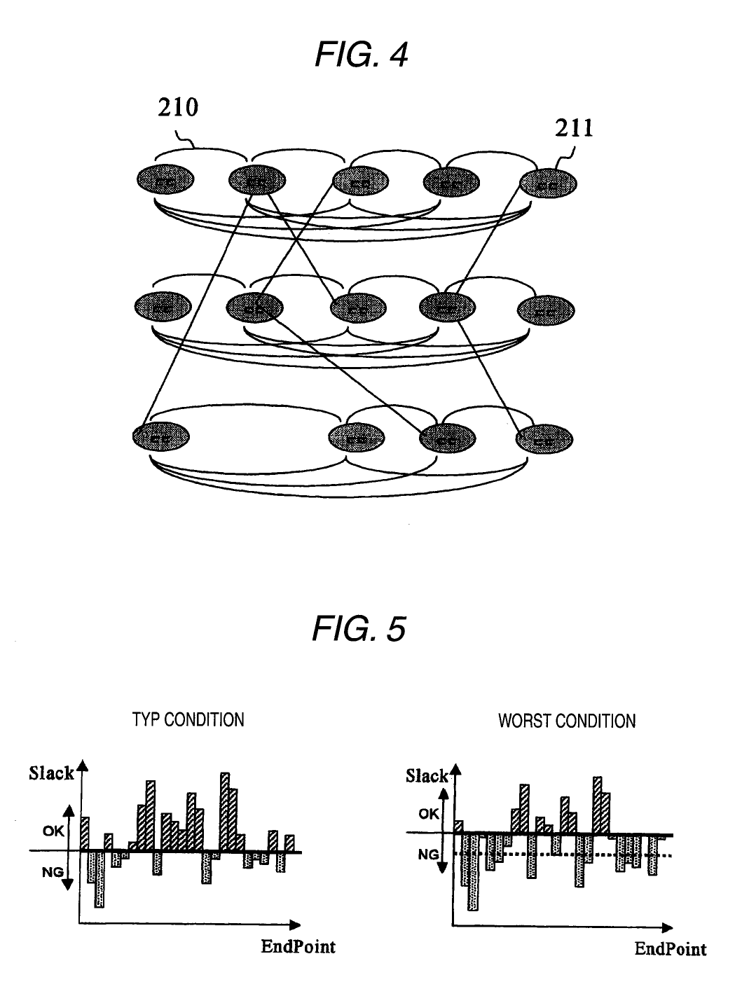

FIG. 4 represents a relationship diagram as to data propagations among the flip-flops. In FIG. 4, reference numeral 210 shows information (data propagation relationship information) indicative of such a relationship that the data are propagated among the flip-flops. Reference numeral 211 shows the flip-flops. FIG. 5 shows a timing margin graph and a timing violation graph every path, namely, indicates analysis information acquired in the detailed timing analyzing step 118.

A feature of the designing method according to the embodiment mode 1 is given as follows: That is, in the rough CTS step 111, instead of the target value of the Skew employed in the conventional designing method, while the adjustable value by switching the clock signal phase is employed as a target value (for instance, if clock signal frequency is 125 MHz, then clock signal phase is 8 ns), the CTS is performed with respect to this target value. Then, the designing method of this embodiment mode 1 is carried out in this order from the wiring line step 112, the LPE step 113, the delay time calculating step 114, and the timing check step 115.

Then, in the timing analyzing step 116, the data propagation relationship information 210 indicative of such a relationship that the data are propagated among the flip-flops based upon the net list and the timing check result. In the analysis path selecting step 117, a selection is made of one of subject paths based upon the above-described data propagation relationship information 210, while the subject paths contain flip-flops which are violated in the timing check result. Then, in the detailed timing analyzing step 118, a timing violation relationship and a timing margin relationship are extracted every check condition based upon the selected analysis path, as represented in FIG. 5, so as to judge whether or not supply timing of a clock signal can be adjusted by shifting a phase of the clock signal.

Concretely speaking, the detail timing analyzing step 118 sequentially adds such a value that violation portions and margin portions correspond to how many pieces of phase intervals from a head-positioned flip-flop based upon a Typ condition, while the violation portions are defined as minus values and the margin portions are defined as plus values, and at the same time, records the added value, and then, transfers the added value to the succeeding steps. When the added result becomes minus, the detail timing analyzing step 118 judges that the supply timing of the clock signal cannot be adjusted, whereas when the added result becomes minus, the detail timing analyzing step 118 judges that the supply timing of the clock signal can be adjusted.

Next, even under the worst condition, a similar calculation is carried out. If such a portion which is judged as “not adjustable” is found out, then this found portion is assumed as such a path to which the phase adjustment only under the Typ condition should be performed, and further, the adjustment depending upon the condition should be performed (refer to embodiment mode 3). Based upon the adjusted result, in the re-allocating step 119 of the CLK net, a phase of a clock signal which does not cause a timing violation is allocated every flip-flop. Then, in the ECO step 120, wiring lines in the layout are re-assembled. In this stage, the designing method is returned to the previous LPE step in which the timing check is again carried out, and then, a series of these designing steps is repeatedly carried out until a timing violation can be eliminated, or timing violations are not reduced.

It should be understood that in the re-allocating step 119 of the CLK net, when a clock signal phase is allocated, this clock signal phase may be alternatively allocated by considering a delay difference between the repeaters 105.

As previously described, in accordance with the designing method of the embodiment mode 1, while the clock signals are supplied in the multiple phases as the initial condition, as the solution for the timing errors, the clock signal phases are re-allocated by shifting the phases along the plus direction, or the minus direction. As a result, the semiconductor device can be designed in such a manner that the clock signals are supplied to be coincident with the propagation times on the side of the data. As a consequence, in accordance with the above-described designing method, the insertion of such a delay buffer can be eliminated, while this delay buffer is inserted only for the timing adjustment and therefore is the useless buffer in view of the function of the semiconductor device. As a result, the current and the area of the semiconductor device can be decreased.

### Embodiment Mode 2

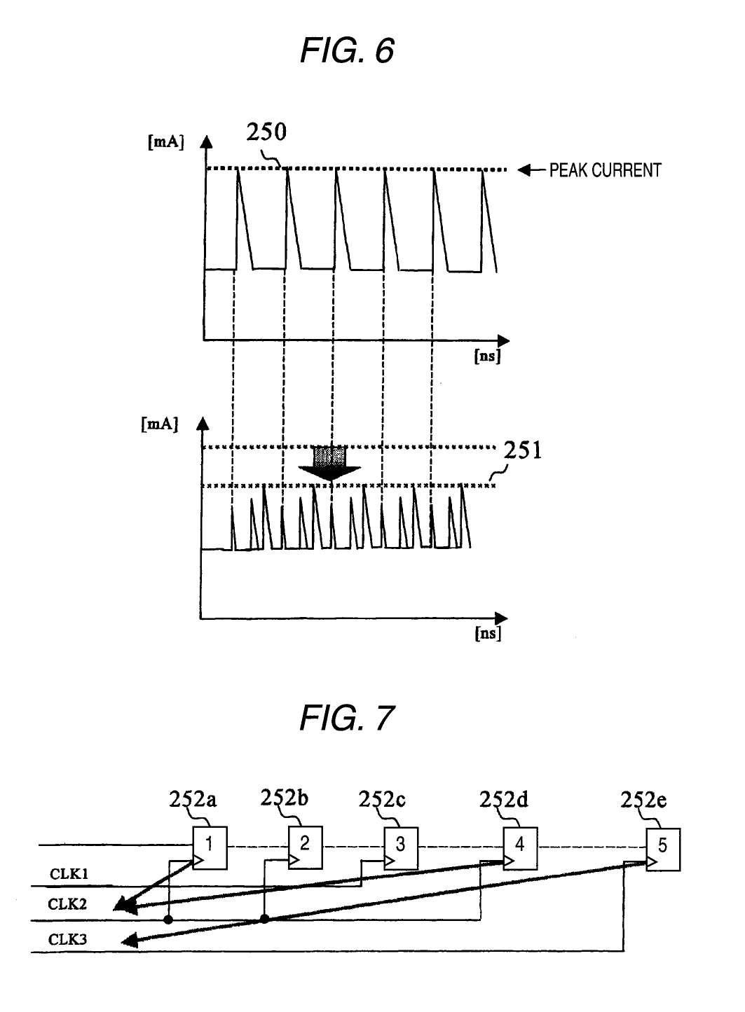

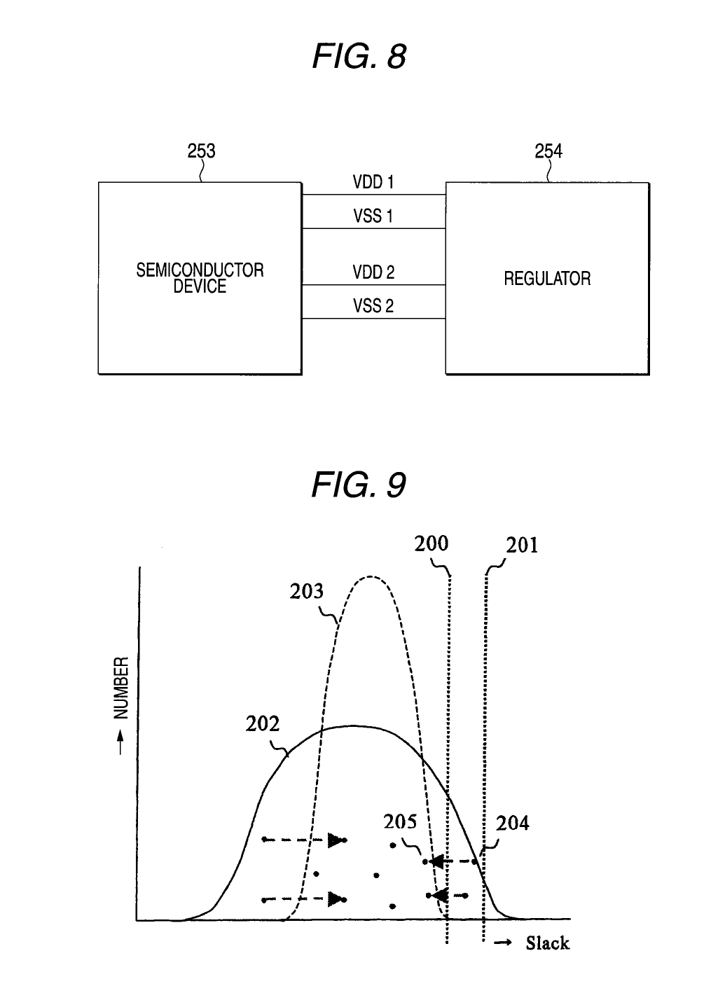

Next, a description is made of a method for designing a semiconductor device, according to an embodiment mode 2 of the present invention. It should be noted that the same reference numerals shown in the above-described embodiment mode 1 will be employed as those for denoting the same structural elements indicated in the embodiment mode 2, and therefore, detailed explanations thereof will be omitted. FIG. 6 is an explanatory diagram for explaining a reduction of peak power. FIG. 7 is a schematic structural diagram of the semiconductor device which is designed based upon the designing method of the embodiment mode 2. FIG. 8 show a relationship diagram between the semiconductor device of FIG. 7 and a regulator.

In FIG. 6, reference numeral 250 shows a peak current value as to an initial condition of a clock signal phase. Reference numeral 251 represents a distributed peak current value. In FIG. 7, reference numerals 252a, 252b, 252c, 252d, and 252e indicate flip-flops, respectively. In FIG. 8, reference numeral 253 shows a semiconductor device to which the designing method of the embodiment mode 2 is applied, and reference numeral 254 represents a regulator which supplies electric power of a power source to the above-described semiconductor device 253. This regulator 254 is mounted on a system in combination with a semiconductor device.

It is so assumed that a peak current value under such a condition that a CLK pin under initial condition has been connected to CLK is a value indicated by reference numeral 250. It is further assumed that both the flip-flops 252a and 252d perform a holding violation, the flip-flop 252c performs a set-up violation based upon the information obtained from the detailed timing analyzing step 118; the respective flip-flops 252a, 252c, 252d are operated under normal condition by shifting a phase of a clock signal by 1 phase; and the flip-flop 252e has a holding margin equal to two phases.

In this case, since the flip-flop 252a performs the holding violation, the clock signal is supplied in a one preceding phase. In the flip-flops at the post stage of the flip-flop 252a, since the timing can be established due to a relationship of data propagation times with respect to the flip-flop at the prestage, the clock signals are once supplied to all of the flip-flops 252b, 252c, 252e in one preceding phases.

Next, since a violation of timing does not occur in the flip-flop 252b, this flip-flop 252b remains under present condition. Since a violation of set-up occurs in the flip-flop 252c, one succeeding clock signal phase is supplied thereto. As a result, the resulting phase becomes “−1+1=0”, the clock signal phases for the flip-flops 252d and 252e are also once changed.

Since the holding violation occurs in the flip-flop 252d, the clock signal is supplied in one preceding phase. The supply phase of the clock signal for the flip-flop 252e becomes “−1+2=+1.” Since a series of the above-described operations are repeatedly carried out in all of paths, the supply timing of the clock signals are naturally shifted, so that the peak current is reduced. In the timing analyzing step 116, the entire clock signal phase is largely moved every path and the above-described operations are carried out, so that the peak current can be reduced to the target current value. As a consequence, it is possible to reduce such a timing design margin by considering a local voltage drop of the power supply within a semiconductor chip when the semiconductor chip is operated. Furthermore, a current supplying capability of the regulator 254 which is mounted on a product with the semiconductor device at the same time may also be reduced, so that the cost of the entire system can be reduced.

### Embodiment Mode 3

Next, a description is made of a method for designing a semiconductor device, according to an embodiment mode 3 of the present invention. It should be noted that the same reference numerals shown in the above-described embodiment mode 1 will be employed as those for denoting the same structural elements indicated in the embodiment mode 3, and therefore, detailed explanations thereof will be omitted.

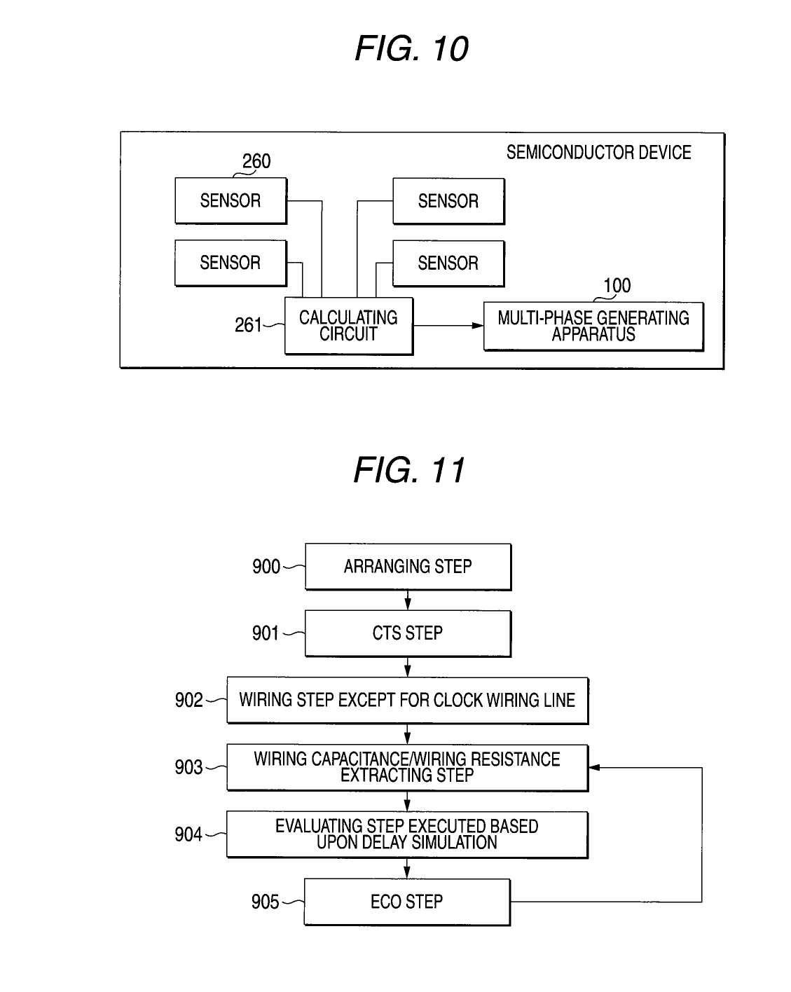

FIG. 9 graphically represents all of timing “Slack.” FIG. 10 shows a schematic structural diagram of a semiconductor device which has been designed in accordance with the designing method of the embodiment mode 3. In FIG. 9, reference numeral 200 indicates timing checked values under the worst condition, namely, a left-sided timing checked value indicates a “margin”, whereas a right-sided timing checked value indicates a “violation.” Reference numeral 201 indicates timing checked values under the Typ condition, namely, a left-sided timing checked value indicates a “margin”, whereas a right-sided timing checked value indicates a “violation.”

Reference numeral 202 represents a distribution of timing checked results under the initial condition. Reference numeral 203 shows a distribution of timing checked results after a phase of a clock signal phase has been adjusted. Reference numeral 204 indicates a timing violation every flip-flop under the initial condition as well as the worst condition. Reference numeral 205 shows a timing margin every flip-flop when the clock signal phase is adjusted after a semiconductor device has been manufactured in the present invention.

In FIG. 10, reference numeral 260 indicates a sensor for sensing a process fluctuation after the semiconductor device has been manufactured. Reference numeral 261 shows a calculating circuit for adjusting a deviation from the Typ condition based upon a phase of a clock signal, while the deviation is sensed by the sensor 260.

In such a case that only any one sort of larger violations among the set-up violations and the holding violations every clock signal, which are used in the semiconductor device, are adjusted based upon the clock phase in accordance with the designing method of the first embodiment mode, when completion values every chip which are acquired form the plurality of sensors 260 arranged at arbitrary positions within the semiconductor device are present within a range from a Typ value up to a best value, the completion values are directly employed, whereas when completion values every chip are present within a range from the Typ value up to the worst value, a deviation width from the Typ condition 201 is calculated by the calculating circuit 261 so as to obtain a correction value with respect to each of the clock signal phase values, and then, these calculated correction values are fed back to the multi-phase generating apparatus 100. As a result, such a flip-flop which is brought into the timing violation in the range from the Typ condition to the worst condition can be operated under normal condition.

Also, since the sensors 260 are previously arranged at such portions that timing variations due to local temperature increases and voltage drops of the power source are critical, a high-precision feedback to the clock signal phase can be realized.

The designing method of the semiconductor device, according to the present invention, may be advantageously utilized for designing not only a single semiconductor device, but also for designing an entire apparatus where, for instance, major components of a domestic electrical appliance have been assembled in a package, and also for designing a digital domestic electric appliance, and thus, may be realized in flexible structures in response to purposes.

What is claimed is:

1. A method for designing a clock synchronization type semiconductor device, comprising:
a rough CTS (clock tree synthesis) step for performing the CTS within an adjustable range in multiple phases;
a timing check step for judging whether or not transmission/reception of data are carried out under normal condition based upon a propagation time of data and an arrival time of a clock signal between flip-flops;
a detailed timing analyzing step for judging whether or not the transmission/reception of the data can be carried out under the normal condition by switching a phase of a clock signal, or by increasing/decreasing a buffer in a half way of the clock tree as to supply timing of the clock signal; and
a re-allocating step of a CLK net, for allocating a phase of such a clock signal which does not cause a timing violation every flip-flop based upon the result of said detailed timing analyzing step.

2. The method for designing a semiconductor device as claimed in claim 1 wherein:
in said detailed timing analyzing step, a delay difference between repeaters is considered which are arranged between a supply source of the clock signal and the clock tree.

3. The method for designing a semiconductor device as claimed in claim 1, wherein:
in said CLK net re-allocating step, the phase of the clock signal is changed by referring to a peak current so as to reduce said peak current.

4. The method for designing a semiconductor device as claimed in claim 1 wherein:
in said detailed timing analyzing step,
both a measuring step for measuring a manufacturing fluctuation of a process, and a correction value calculating step for calculating a correction value which corrects a deviation width with respect to a Typ condition every clock signal phase value based upon the measurement result are carried out; and wherein:
in said CLK net re-allocating step, the phase of the clock signal is changed by referring to said correction value so as to allocate the changed clock signal phase.

5. The semiconductor device manufactured by the method as recited in claim 1.

6. A semiconductor device as claimed in claim 5 wherein said semiconductor device is comprised of:
a multi-phase generating apparatus capable of supply clock signals having a plurality of phases;
a measuring circuit for measuring a manufacture fluctuation of a process;
a calculating circuit for calculating a correction value of a phase of the clock signal based upon a deviation width from a Typ condition; and
an adjusting unit for adjusting a timing violation under the worst condition after said semiconductor device has been manufactured.

7. The semiconductor device as claimed in claim 6 wherein:
said multi-phase generating apparatus is arranged by a PLL (phase-locked loop) circuit.

8. The semiconductor device as claimed in claim 6, wherein:
a phase generating unit of said multi-phase generating apparatus is constituted by an MOS (metal oxide semiconductor) element having a delay function.
